(19) United States
(12) Patent Application Publication
(10) Pub. No.: US 2002/0161520 A1
(43) Pub. Date: Oct. 31, 2002

(54) Method to display allowed parking areas in a vehicle

(75) Inventors: Rabindranath Dutta, Austin, TX (US); Michael A. Paolini, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/844,391

(22) Filed: Apr. 27, 2001

(51) Int. Cl. G01C 21/00; G01C 21/30; G01C 21/32; G01C 21/26; G01C 21/28; G01C 21/34; G01C 21/36; G01S 1/00; H04B 7/185

(52) U.S. Cl. 701/213; 342/357.17; 701/208

(57) ABSTRACT

A method, system and computer program product for conveying parking area availability information to an operator of a first vehicle traveling in a metropolitan area. Geographic position data is obtained for the first vehicle. The geographic position date is used to retrieve information about parking area availability for an area associated with the geographic position data. The information is then presented to the operator.

### CROSS-REFERENCE TO RELATED APPLICATIONS

The present invention is related to the following applications entitled “Method to Display Current and Historic Crime Statistics for an Area in a Vehicle”, U.S. application Ser. No. ______, Attorney Docket Number AUS920010120US1 and “Method to Display Regional Traffic Enforcement Practices in a Vehicle”, U.S. application Ser. No. ______, Attorney Docket Number AUS920010121US1; all of which are filed even date hereof, assigned to the same assignee, and incorporated herein by reference.

### BACKGROUND OF THE INVENTION

1. Technical Field

The present invention relates generally to an improved data processing system, and, in particular to an improved data processing system relating to monitoring allowed parking areas in a region. Still more particularly, the present invention provides a method to provide schedules on a road navigation system in which to monitor parking areas in a region.

2. Description of Related Art

The use of computers has become more and more pervasive in society. This pervasiveness includes the integration of personal computers into vehicles. The utilization of computer technology is employed to provide users or drivers with a familiar environment. In this manner, a user's ability to easily use computing resources in an automobile is provided. In addition, it is envisioned that car buyers would be able to use most of the same software elements in an automobile that are used at home or in the office. In addition, an automobile owner could completely customize driver information displays to create an optimal environment for the driver's needs. Various platforms have been developed and are being developed for use in automobiles. Many platforms provide the computing strength of a personal computer platform with widely recognized as well as emerging technologies. Widely accepted technologies that may be implemented within an automobile include, cellular/global system for mobile communications (GSM), global positioning system (GPS), and radio data broadcast (RDB). These devices allow a driver to navigate, receive real-time traffic information and weather forecasts, access databases of personalized information, and place and receive telephone calls, as well as send and receive email and faxes from an automobile. Emerging technologies that are being integrated into computing platforms for automobiles include the universal serial bus (USB) and the digital video disk (DVD).

Prior art road navigation display systems are becoming very popular. These prior art road navigation display systems indicate to a driver of the vehicle the directions for specific routes on a display in the vehicle itself. Road navigation display systems that display a map and indicate directions while driving are typically used by operators of a vehicle who are unfamiliar with an area. Locating a parking spot for a vehicle is one of the most frustrating and stressful activities associated with a large metropolitan area. Often, in the central part of a large metropolitan area, a part of the street is designated as a parking spot and is usually provided with a parking meter to charge an operator of the vehicle for use of the parking spot.

However, many factors impact the privilege of parking on one of these streets. For example certain parts of busy metropolitan streets are closed to parking during daylight hours of weekdays due to the large amount of traffic using these streets to enter and exit the metropolitan area. Also, street maintenance, such as road repair, street cleaning, snow removal and the like may impact using a parking spot located on a metropolitan street. In addition, large lots in the central part of a large metropolitan area are dedicated to parking areas. However, these lots may also have restrictions to parking on them during certain times. For example, some central metropolitan parking lots are reserved for only contract parking, some are dedicated only to employees of a certain business, eventually all parking lots have to close for repairs, re-striping and the like. Unfortunately, vehicle operators usually do not know before a parking spot is needed that certain parking facilities are either permanently or temporarily off limits to parking. Either the information is not available to an operator of a vehicle before the parking spot is needed or the information is not available in the vehicle itself. Therefore, it would be advantageous to have a method and system for providing an indication of allowed parking areas and parking bans in a vehicle.

### SUMMARY OF THE INVENTION

The present invention provides a system, method and computer program product for displaying allowed parking areas and parking bans in a metropolitan area in which a vehicle is either traveling or plans to travel. The present invention provides a mechanism by which a parking area closure schedule is stored and presented to an operator of a vehicle regarding a section of the metropolitan area in which the vehicle is located. In addition, the present invention may provide data to the management of a parking facility indicting to the management which areas of the parking facility are full and which spaces in the parking facility are currently being utilized.

The parking area closure schedule is compiled and analyzed to determine parking closure areas in which the vehicle is located. These parking closure areas provide an indicator to a traveler in the metropolitan area in which parking is either allowed or not allowed. Thus, a more complete analysis of a cental metropolitan area may be presented to the driver of the vehicle in view of information gathered from area municipalities and parking facility managers to inform the operator and management of the parking facilities about the status of parking areas in the cental metropolitan area. The operator and parking facility management may be alerted to the closure of parking areas within the central metropolitan area because of a variety of factors, both permanent and temporary.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a networked data processing system in accordance with the present invention;

FIG. 2 is an exemplary block diagram of a data processing system that may be used to implement the server of the present invention;

FIG. 3 is an exemplary block diagram of a data processing system that may be used to implement a client system in accordance with the present invention;

FIG. 4 is an exemplary functional block diagram of a client device in accordance with the present invention;

FIG. 5 is an exemplary functional block diagram of a server in accordance with the present invention;

FIG. 6 is an exemplary diagram of a parking area database in accordance with the present invention;

FIG. 7 is an exemplary portion of a road system in a metropolitan area as an example to illustrate the operation of the present invention in accordance with the present invention; and

FIG. 8 is a flowchart outlining an exemplary operation of providing parking area availability information for a metropolitan area in accordance with a preferred embodiment of the present invention.

### DETAILED DESCRIPTION OF THE PREFERRED EMBODIMENT

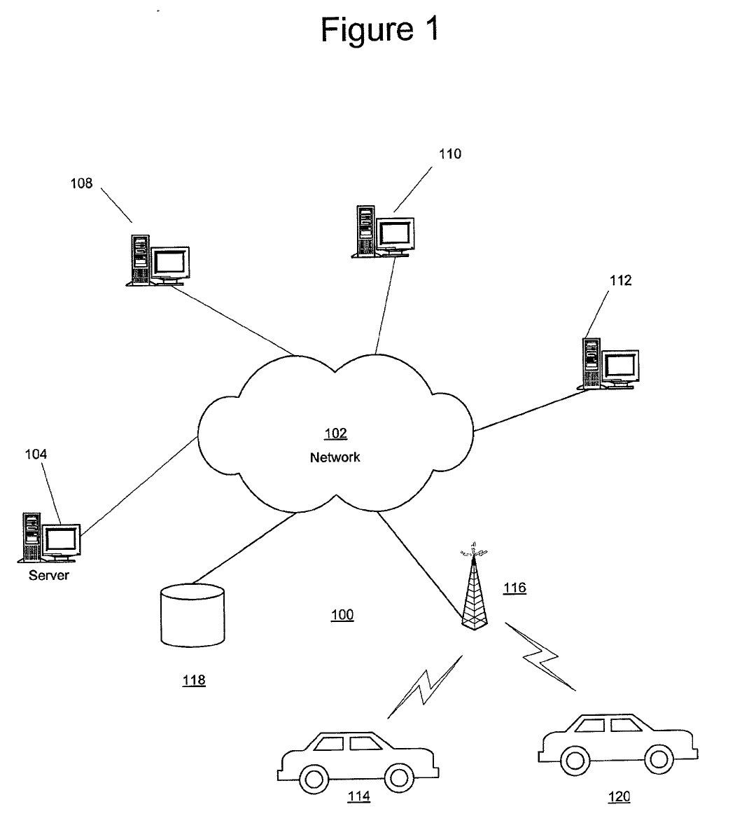

With reference now to the figures, FIG. 1 is an exemplary block diagram of a networked data processing system in accordance with the present invention. Network data processing system 100 is a network of computers in which the present invention may be implemented. Network data processing system 100 contains a network 102, which is the medium used to provide communications links between various devices and computers connected together within network data processing system 100. Network 102 may include wireline connections, such as copper wire or fiber optic cables, and wireless connections, such as cellular telephone connections. Also, the connections for network 102 may be either permanent, such as with a dedicated line, and/or temporary, such as connections made through dial up telephone connections.

In the depicted example, server 104 is connected to network 102. In addition, parking area availability data supplier systems 108-112 are also connected to network 102. The parking area availability data supplier systems 108-112 may be, for example, personal computers, portable computers, servers, databases, mainframe computers, or the like. The parking area availability data supplier systems 108-112 supply parking area availability information regarding portions of a metropolitan area to server 104. Network data processing system 100 may include additional servers, parking area availability data supplier systems, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

The parking area availability data suppliers 108-112 provide parking area availability data to server 104. The parking area availability data may be any type of parking area availability data in, for example, a metropolitan area. For purposes of this application, parking availability is described for a metropolitan area or a section of a metropolitan area. However, other areas may use the mechanism of the present invention within the spirit and scope of the present invention. Parking area availability information may also be gathered and distributed for other areas, including, but not limited to, rural areas, small cities, parking garages, parking lots, and the like. As a further example, parking area availability data may include parking areas designated only for contract parking, parking areas closed due to street maintenance, parking areas closed due to temporary street cleaning, and the like. This information may be provided along with indicators of date and time of the expected closure of the parking areas. In addition, the parking area availability data may be very recent data only a few seconds or a few minutes old. Furthermore, the parking area availability data may be “live” data which is currently ongoing in a certain part of the metropolitan area and may contain data regarding special parking area availability, such as for example, handicapped parking, authorization for reserved parking spaces, leased parking spaces, and the like. The special parking area availability may override the parking area availability data and thereby giving occupants of a vehicle with special needs or special status priority over general parking area availability information.

The parking area availability data provided by the parking area availability data suppliers 108-112 is preferably compartmentalized into established routing sections. That is, within a geographical area, routing sections are defined and established as a means by which parking area availability data is reported. For example, a section may be a section of a metropolitan area existing between intersections of a roadway, a section of a route existing between two landmarks, a section of a metropolitan area between two points which may be set deliberately or arbitrarily, and the like.

The parking area availability data is compartmentalized into sections each having various characteristics. Thus, for section 1, parking area availability data may be compiled. This information is preferably stored in a database in the respective parking area availability data suppliers 108-112 until it is ready for upload to server 104. The information may be stored in a manner such that the data is indexed by a section designator, for example.

Server 104 receives the parking area availability data from the parking area availability data suppliers 108-112, compiles and correlates the parking area availability data to determine parking availability of each section of a metropolitan area, and stores or updates the parking availability of each section of a metropolitan area in database 118. In addition to the parking area availability data from the parking area availability data suppliers 108-112, current parking area availability information from one or more vehicles is provided to server 104. The current parking area availability information provides, for example, information relating to emergency closure of a parking area, nonreported closing of a parking area, capacity of a parking area, and the like. The current parking area availability information provides, for example, information relating to ongoing parking area availability, most recent past parking area availability, and the like. This information is also used to identify various area characteristics containing sections of the metropolitan area. For example, a vehicle operator that has recently tried to find an available parking area and has failed to do so may upload data about the available parking area situation in a section of the metropolitan area. This current or recent parking area availability may be relayed to an operator of another vehicle, for example, via a wireless connection as a result of a query. For example, the operator of the vehicle which has been unable to find an available parking area may upload data pertaining to the location of the metropolitan area and the inability to locate an available parking area. An operator of another vehicle may, for example, enter a road name, a mile marker, a city identifier, a section of the metropolitan area, and the like, and find out if current or recent parking area availability has been reported. With the combined parking area availability data from parking area availability data suppliers and the current and recent parking area availability from one or more vehicles, this combined information may be used to show, for example, where available parking spaces are located, for example, in a metropolitan area, in a real time fashion. With the use of the current parking area availability information, vehicles operators as well as, for example, parking lot management and parking garage management may be kept apprised of the current capacity of the parking areas as well as information regarding which spaces in the parking lots and parking garages are currently occupied and unoccupied.

The parking area availability information may be reported to server 104 by way of a wireless transmitter in a vehicle, such as vehicle 114. The wireless transmitter sends the current parking area availability information to a base station 116 which is coupled to the network 102 via a wired or wireless connection. The base station 116 then transmits the current parking area availability information to server 104 via the network 102. The current parking area availability information may be uploaded from the vehicle 114 to server 104 via the base station 116 upon the occurrence of an event, at predetermined time intervals, or the like.

The parking area availability data obtained from the parking area availability data suppliers 108-112 and the current parking availability information are correlated to determine parking availability of each section of a metropolitan area. The parking availability of each section of a metropolitan area are stored in the database 118 of server 104. From the parking availability of each section of a metropolitan area stored in the database 118 of server 104, probabilities of being able to locate an available parking space may be determined. The probability information may be utilized along with user selections of parking area criteria, to alert an operator of the parking area availability associated with a section of the metropolitan area. The user parking area criteria, may be, for example, whether the vehicle can use a compact car parking space, whether two adjoining parking spaces are required for a trailer attached to the vehicle, whether an end parking space is desired, and the like may be factored into the probability determination. The parking availability of each section of a metropolitan area are displayed in vehicle 120 by various means. For example, the parking availability of each section of a metropolitan area may be displayed in a vehicle by, for example, a display device, a personal digital assistant, a hand-held computer, and the like, located inside the vehicle. For example, the parking availability may be displayed in a vehicle by, for example, a display device, a personal digital assistant, a hand-held computer, and the like, located inside the vehicle. In addition, a means of displaying parking availability characteristics in a vehicle may be, for example, by overlaying a semi-transparent color over a region which may indicate which parking areas in a section of the metropolitan are occupied or unoccupied. For example, the overlay may be a green or red color, with the red overlay indicating which parking areas are currently being used and the green color indicating which parking areas are currently available. Another example, may be by marking particular spots in which parking area availability is being used or is currently unoccupied. A graphical display, such as, for example, an icon may be used to indicate such areas. An icon may be displayed ranging from solid icons to semi-transparent icons. The solid icons may, for example, signify which parking areas have been occupied for a significant amount of time which may indicate that the parking area is being used for work related parking and may continue to be occupied until business hours are over. Alternatively, a semitransparent icon may signify which parking areas have only been occupied for a short amount of time which may indicate that the parking area is being used for shopping related parking and may become available within a shorter amount of time.

In another embodiment, the present invention provides for tracking parking area availability data to be displayed for the area in which the vehicle is presently traveling. The present location of the vehicle is associated with an section of a metropolitan area. Parking area availability data is obtained for this area based on the location of the vehicle. The parking area availability data may be transmitted to the vehicle and displayed within the vehicle. The present location of the vehicle may be determined by using, for example, an onboard global positioning system. The location information may be sent by an onboard mobile computer system or may be defined by the driver of the vehicle. The onboard mobile computer system may be, for example, a notebook computer, a personal digital assistant (PDA), an on board navigation system and an onboard computer, and the like. The driver of the vehicle may define the location of the vehicle by using, for example, road names, road numbers, mile markers, cross streets, cities, counties, states, zip codes, and the like. The transmission of the location information of the vehicle may be transmitted by a onboard navigation system.

If the vehicle is approaching a section of the metropolitan area, an alert may be given to warn the driver of the fact that there is no available parking in the immediate area. This alert may help the driver decide to search for parking in another section of the metropolitan area or at least be aware of the lack of parking areas in the immediate section of the metropolitan area. This alert may be textual, audible or tactile. A textual alert may be displayed in alternate ways so as to effectively warn the operator of lack of parking areas. For example, the textual alert may flash, consist of bold lettering, consist of large text size, and the like. An audible alert may be transmitted by a plurality of sounds, such as for example, whistle, a bell, a siren, and the like. Additionally, two or more of the alerts may be used in concert with one another. For example, a flashing textual message may be used with a whistling audible alert when approaching a metropolitan area of a city with no available parking. In addition, an alert may be displayed so as to inform an operator of the vehicle that there is available parking in the area using the textual, audible or tactile means.

Other ways of alerting a driver of a vehicle as to a section of the metropolitan area with no parking areas based on current parking area availability and stored parking area availability may be used without departing from the spirit and scope of the present invention. For example, expert systems, neural networks, rule based systems, inference engines, data mining techniques, and the like, may be used to identify parking area availability in a section of the metropolitan area based on the current and historical data obtained from the parking area availability data suppliers 108-112 and criteria entered by a user.

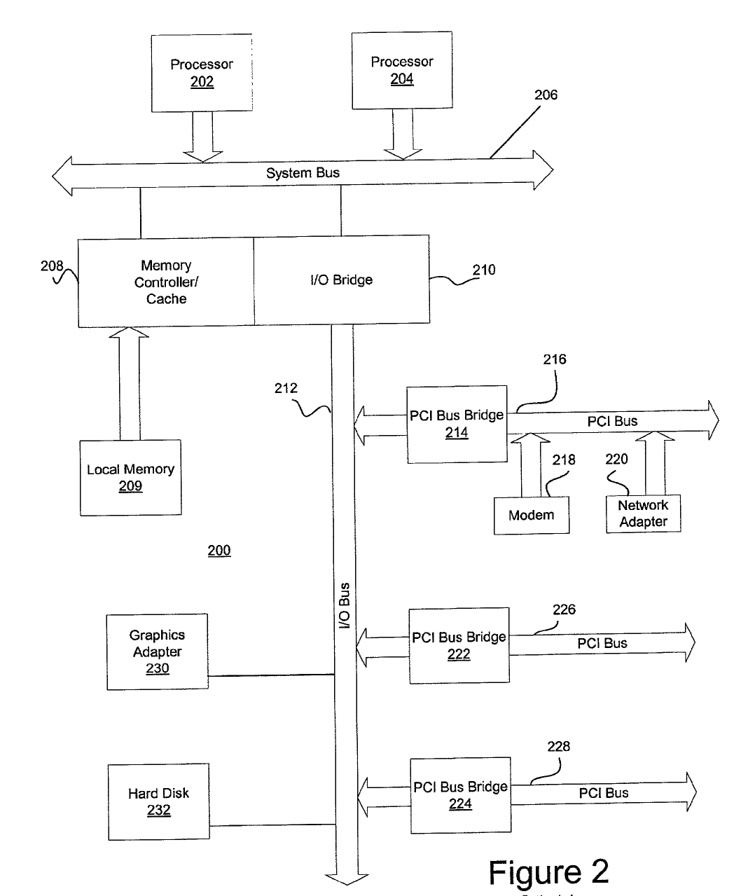

FIG. 2 is an exemplary block diagram of a data processing system that may be used to implement the server of the present invention. FIG. 2 may be implemented as a server, such as server 104 or parking area availability data suppliers 108-112 in FIG. 1. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM RISC/System 6000 system, a product of International Business Machines Corporation in Armonk, New York, running the Advanced Interactive Executive (AIX) operating system.

The data processing system in FIG. 2 may execute one or more stored applications for performing the various functions of the present invention. Alternatively, the functionality of the present invention may be “hardwired” into the hardware of the data processing system or into additional components coupled to the data processing system shown in FIG. 2. It will be assumed for purposes of the description of the present invention that the invention is implemented as machine readable instructions that are executed by the data processing system shown in FIG. 2, although it should be appreciated that the present invention is not limited to such an embodiment.

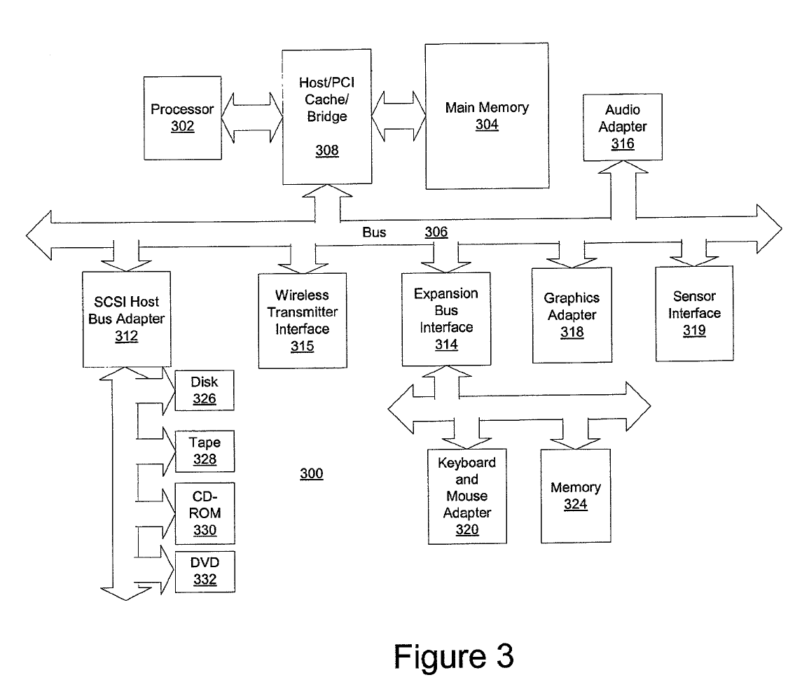

FIG. 3 is an exemplary block diagram of a data processing system that may be used to implement a client system in accordance with the present invention. Data processing system 300 is an example of a client computer, such as a computer installed in vehicle 114, for example. Although in a preferred embodiment, the client computer is positioned in a vehicle, the invention is not limited to such. Rather, the client computer may be a standard desktop computer, laptop computer, personal digital assistant, or the like, and may not be associated directly with a vehicle.

In addition, the data processing system 300 shown in FIG. 3 employs a peripheral component interconnect (PCI) local bus architecture. Although the depicted example employs a PCI bus, other bus architectures such as Accelerated Graphics Port (AGP) and Industry Standard Architecture (ISA) may be used.

Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, SCSI host bus adapter 312, expansion bus interface 314 and wireless transmitter interface 315 are connected to PCI local bus 306 by direct component connection. In contrast, audio adapter 316, graphics adapter 318, and sensor interface 319 are connected to PCI local bus 306 by add-in boards inserted into expansion slots.

Expansion bus interface 314 provides a connection for a keyboard and/or pointing device adapter 320 and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system may run on processor 302 and may be used to coordinate and provide control of various components within data processing system 300 in FIG. 3. The operating system may be a commercially available operating system, such as Linux or Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. In addition, rather than a keyboard or pointing device, a touchscreen or other input/output device adapter may be used. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

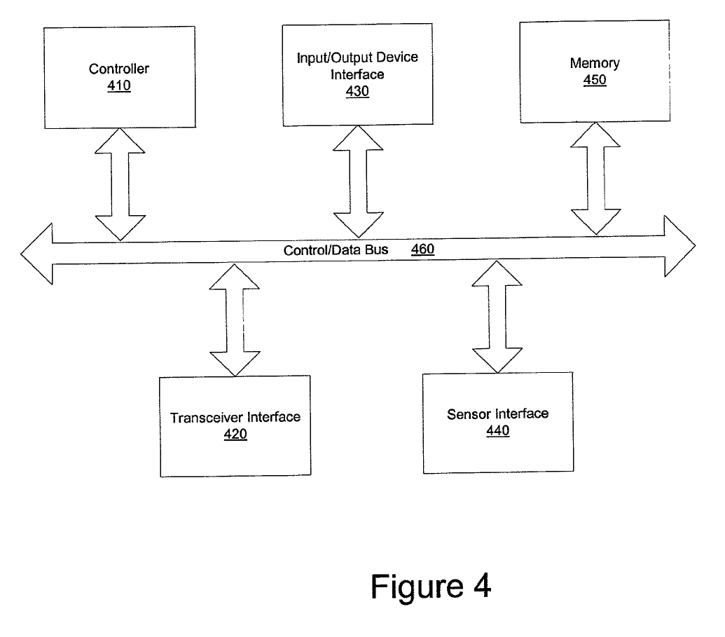

FIG. 4 is an exemplary functional block diagram of a client device in accordance with the present invention. The elements of the functional block diagram of FIG. 4 may be implemented as hardware, software, or a combination of hardware and software components. In a preferred embodiment, the functional elements shown in FIG. 4 are implemented as software instructions executed by one or more of the hardware elements shown in FIG. 3.

As shown in FIG. 4, the client device includes a controller 410, a transceiver interface 420, an input/output device interface 430, a sensor interface 440, and a memory 450. These elements are in communication with one another via the control/data bus 460. Although a bus architecture is shown in FIG. 4, the present invention is not limited to such and any architecture allowing for the communication of control messages and data between the elements 410-450 may be used without departing from the spirit and scope of the present invention.

The controller 410 controls the overall operation of the client device. The controller 410 receives input from a user via the input/output interface 430 and sends requests for parking area availability information to a server via the transceiver interface 420. The controller 410 receives the parking area availability information from the server and causes the information to be displayed to the user via the input/output interface 430 and an output device coupled to the input/output interface 430 (not shown).

In addition, the controller 410 receives sensor data via the sensor interface 440 and stores the sensor data in memory 450 in association with a section of the current route being used by the vehicle. For example, the sensor data may comprise position data from a global positioning system, and the like. The position data may be used to determine a current position along a current route. This information may be uploaded to the server via the transceiver interface 420.

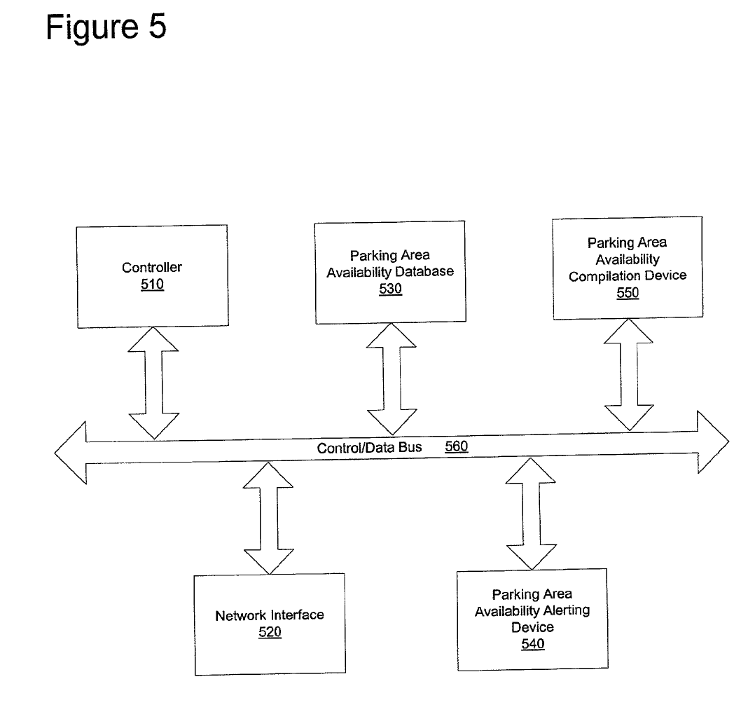

FIG. 5 is an exemplary functional block diagram of a server in accordance with the present invention. As with the client device shown in FIG. 4, the elements of the functional block diagram of FIG. 5 may be implemented as hardware, software, or a combination of hardware and software components. In a preferred embodiment, the functional elements shown in FIG. 5 are implemented as software instructions executed by one or more of the hardware elements shown in FIG. 2.

As shown in FIG. 5, the server includes a controller 510, a network interface 520, a parking area availability database 530, a parking area availability alerting device 540 and a parking area availability data compilation device 550. These elements are coupled with one another via the control/data bus 560. Although a bus architecture is shown in FIG. 5, the present invention is not limited to such and any architecture allowing for the communication of control messages and data between the elements 510-550 may be used without departing from the spirit and scope of the present invention.

The controller 510 controls the overall operation of the server. The controller 510 receives sensor data, parking area availability data and requests for current location information via the network interface 520. The sensor data and parking area availability data are compiled by the parking area availability data compilation device 550 to identify parking availability of each section of a metropolitan area.

The parking availability of each section of a metropolitan area generated by the data parking area availability compilation device 550 is then stored in the parking area availability database 530 in association with an identifier of the current route section or used to update already existing entries in the parking area availability database 530. The parking area availability information may then be used by the parking area availability alerting device 540 to identify that there is no available parking in the immediate area.

The parking area availability alerting device 540 receives the parameters included in the request for parking area availability information received from the client device. The parameters, that may be input by a user, may include, for example, a parking area size, adjacent available parking areas, handicapped parking, height limitations of a parking are and preferences for an area in which a parking area is located. Based on this information, the parking area availability alerting device 540 identifies one or more available parking areas within the section of the metropolitan area. The one or more available parking areas within the section of the metropolitan area are determined based on parking area availability information stored in the parking area availability alerting device 540. This parking area availability information may include, for example, whether there exists within a section of the metropolitan area an unoccupied parking area, whether there is snow removal or street cleaning scheduled for the area, and the like. The sections that make up each part of the metropolitan area are then analyzed and the parking area availability information is analyzed to determine if the driver of the vehicle should be alerted as to the unavailability of a parking area in the section of the metropolitan area.

The parking area availability information may then be transmitted to the client device via the network interface 520. The parking area availability information may include the portions of the metropolitan area as well as any additional information that may be of use to the client device when instructing the user regarding availability of parking areas. The client device may use this information in any one of many possible ways to inform the user of availability of parking areas within a section of the metropolitan area in which the vehicle is either presently traveling or plans to travel.

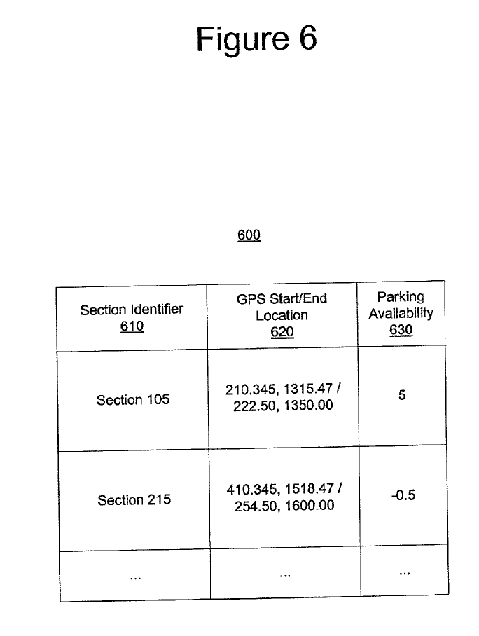

FIG. 6 is an exemplary diagram of a parking area database in accordance with the present invention. The particular field and organization shown in FIG. 6 is for illustrative purposes only and any other fields or organization may be used in addition to or in replacement of those shown in FIG. 6 without departing from the spirit and scope of the present invention.

As shown in FIG. 6, the parking area availability information database includes a field 610 for a section identifier, a field 620 for a GPS start location and GPS end location of the section, and field 630 for storing identifiers of the various characteristics of the section. In the particular example shown in FIG. 6, the characteristic includes a parking area availability condition. This characteristic has a score associated with a section. The scores in the characteristic fields 630 are used when generating a total score for a section.

When the parking area availability alerting device 540 retrieves information for sections of a the metropolitan area from the parking area availability database, the parking area availability information is used, along with weights, determined based on parameters received in the request from the client device, to determine a score for each section of the metropolitan area. This is done for each section of the metropolitan area.

While the example shown in FIG. 6 makes use of score identifiers in characteristic field 630, other identifiers may be used without departing from the spirit and scope of the present invention. For example, textual identifiers such as “available”, “unavailable”, and the like may be used rather than numerical scores.

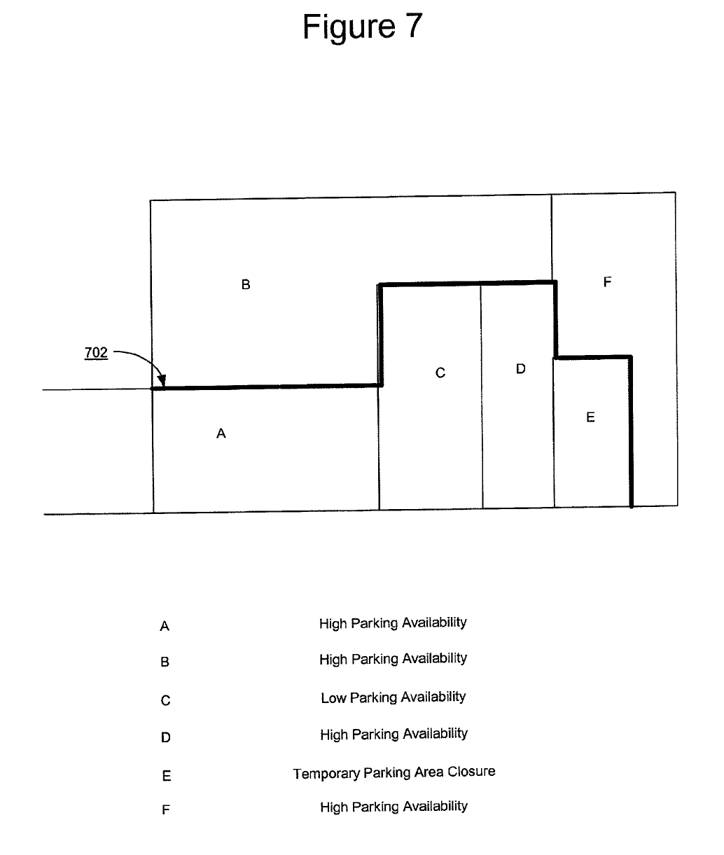

FIG. 7 is an exemplary portion of a road system in a metropolitan area as an example to illustrate the operation of the present invention in accordance with the present invention. With regard to FIG. 7, assume that the operator of vehicle 114 wishes to travel on roadway 702 located in the central business district of a large metropolitan area where parking is sometimes hard to find. In this particular example, it will be assumed that roadway 702 is partitioned into sections designated by intersections of adjoining roadways. Thus, the portion of roadway 702 between two intersections is considered a section.

As shown in FIG. 7, section A has high parking availability, section B has high parking availability, section C has high parking availability, section D has high parking availability, in section E there is a temporary parking area closure throughout the section and section F has a high parking area availability.

If the user of the vehicle wishes to avoid the areas in which there is low parking availability and a temporary closure of all parking in a section, this criteria makes sections C and E less likely to be included in the possible sections of the metropolitan area in which to find a parking area and may be disregarded altogether by the driver which may opt to search for a parking area in sections A, B, D and F which have high parking availability.

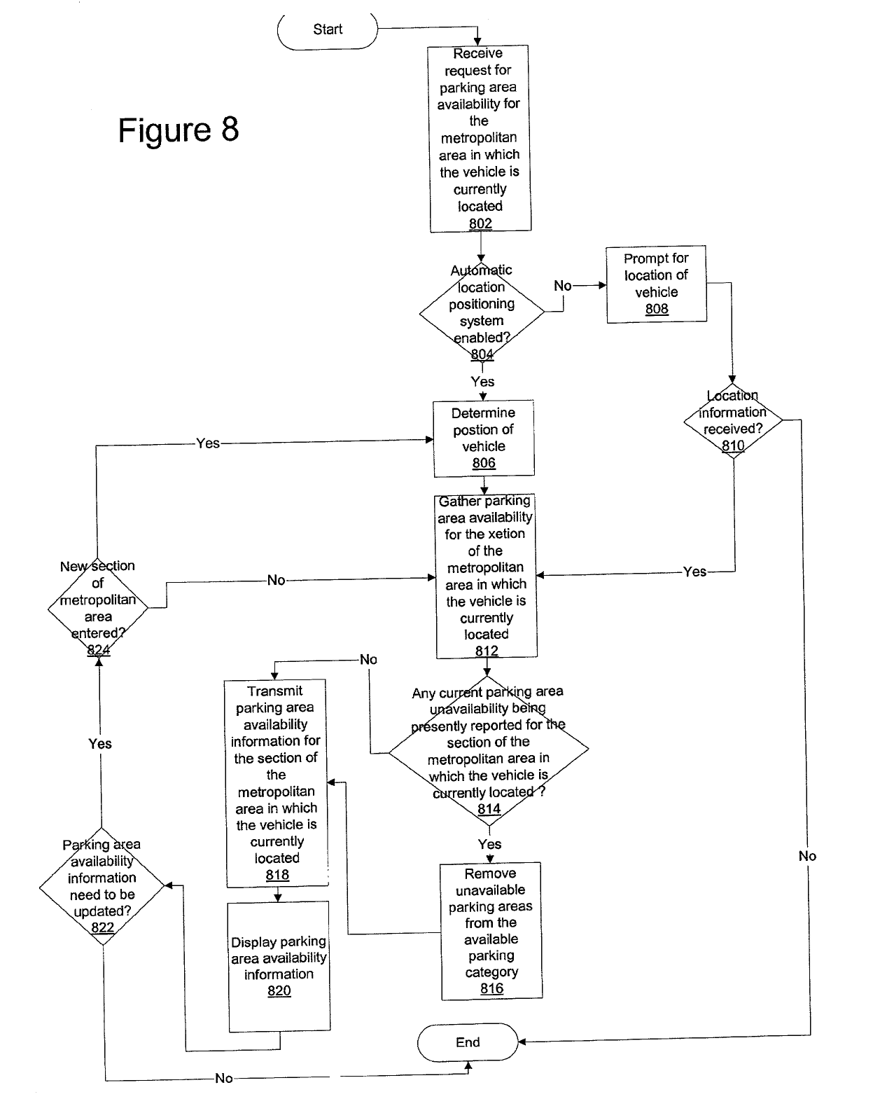

FIG. 8 is a flowchart outlining an exemplary operation of providing parking area availability information for a metropolitan area in accordance with a preferred embodiment of the present invention. In this example, the operation starts with receiving a request for parking area availability for the metropolitan area in which the vehicle is currently located (step 802). Then a determination is made as to whether or not the automatic location positioning system is enabled (step 804). For example, the automatic location positioning system may be a global positioning system (GPS). If the automatic location positioning system is not enabled (step 804:NO), a prompt is made for the location of the vehicle (step 808). Then a determination is made as to whether or not the location information was received (step 810). If the location information was not received (step 810:NO), the operation terminates. If the location information was received (step 810:YES), the operation continues to step 812 in which parking area availability information is gathered for the section of the metropolitan area in which the vehicle is currently located.

Returning to step 804, if the automatic location positioning system is enabled (step 804:YES), the position of the vehicle within the metropolitan area is determined (step 806). Then parking area availability information is gathered for the section of the metropolitan area in which the vehicle is currently located (step 812). Then a determination is made as to whether or not any current parking area unavailability is presently being reported for the section of the metropolitan area in which the vehicle is currently located (step 814). If any current parking area unavailability is being presently reported in the section of the metropolitan area in which the vehicle is currently located (step 814:YES), the parking area(s) being reported as being unavailable are removed from the available parking area category (step 816). Then the operation continues to step 818 in which parking area availability information is transmitted on the section of the of the metropolitan area in which the vehicle is currently located.

If there is not any parking area unavailability being presently reported in the section of the metropolitan area in which the vehicle is currently located (step 814:NO), then parking area availability information is transmitted on the section of the of the metropolitan area in which the vehicle is currently located (step 818). The parking area availability information for the section of the metropolitan area in which the vehicle is currently located is displayed in the vehicle (step 820). Then a determination is made as to whether or not the parking area availability information needs to be updated (step 822). If the parking area availability information does not need to be updated (step 822:NO), the operation terminates. If the parking area availability information needs to be updated (step 822:YES), a determination is made as to whether or not a new section of the metropolitan area has been entered by the vehicle (step 824). If a new section of the metropolitan area has been entered by the vehicle (step 824:YES), the operation returns to step 806 in which the position of the vehicle is determined. If a new section of the metropolitan area has not been entered by the vehicle (step 824:NO), the operation returns to step 812 in which parking area availability information is gathered for the current section of the metropolitan area in which the vehicle is currently located.

Thus, the present invention provides a method for determining parking area availability information of a metropolitan area in which a vehicle is located. A more complete view of the parking area availability in the metropolitan area is presented to a driver of the vehicle so as to eliminate the risk of not being able to find a parking spot at all in a specific section of the metropolitan area and making the driver aware of alternate section of the metropolitan area in which parking areas are available.

While the above embodiments of the present invention have been described in terms of a land vehicle, such as an automobile, the present invention is not limited to any particular type of vehicle. The present invention may be utilized for any type of vehicle, including, for example, a motorcycle, a bicycle, and the like. Thus, the term “vehicle” as it is used in the present application is not meant to be limited to enclosed vehicles but is intended to mean any type of vehicle.

It is important to note that while the present invention has been described in the context of a fully functioning data processing system, those of ordinary skill in the art will appreciate that the processes of the present invention are capable of being distributed in the form of a computer readable medium of instructions in a variety of forms and that the present invention applies equally regardless of the particular type of signal bearing media actually used to carry out the distribution. Examples of computer readable media include recordable-type media such as a floppy disk, a hard disk drive, a RAM, a CD-ROM, and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for conveying parking area availability information for a first vehicle, comprising the steps of:
obtaining geographic position data of the first vehicle;
using the geographic position data to retrieve information about parking area availability for an area associated with the geographic position data; and
presenting the information to an operator.

2. The method as recited in claim 1, wherein obtaining geographic position data of the first vehicle includes obtaining geographic position data from a Global Positioning System (GPS).

3. The method as recited in claim 1, wherein obtaining geographic position data of the first vehicle includes one of a mobile computer system and a user defined position.

4. The method as recited in claim 3, wherein the user defined position includes at least one of a route name, a route number, a route mile marker, a cross street, a city, a county, a state and a zip code.

5. The method as recited in claim 3, wherein the mobile computer system is at least one of a notebook computer, a personal digital assistant (PDA), an on board navigation system, an onboard computer and a cellular telephone.

6. The method as recited in claim 1, wherein the geographic position data is sent by an onboard navigation system.

7. The method as recited in claim 1, further comprising:
receiving from a second vehicle information about unavailability of a parking area in an area associated with the geographic location data; and
presenting the parking area unavailability information to the operator.

8. The method as recited in claim 1, further comprising:
transmitting an alert if the parking area availability of the area associated with the geographical position data exceed a predetermined threshold amount; and
presenting the alert to the operator.

9. The method as recited in claim 8, wherein the alert is at least one of textual, audible and tactile.

10. The method as recited in claim 1, wherein parking area availability information is for a metropolitan area, the metropolitan area being partitioned into sections, and wherein the parking area availability information is obtained for the metropolitan area associated with the section.

11. The method as recited in claim 1, wherein the parking area availability information is obtained from one or more parking area availability data suppliers.

12. The method as recited in claim 11, wherein the parking area availability data suppliers are at least one of a municipality and a private parking area facility.

13. The method as recited in claim 1, wherein conveying parking area availability information to an operator of a first vehicle traveling in a metropolitan area includes using at least one of an expert system, a neural network, a rule based system, an inference engines, and a data mining technique.

14. The method as recited in claim 1, further comprising:
calculating a score for a metropolitan area based on the parking area availability information; and
presenting the score to the operator.

15. The method as recited in claim 14, wherein calculating a score for the metropolitan area based on the parking area availability information includes summing scores for each section of the metropolitan area.

16. The method as recited in claim 1, wherein the operator is at least one of an operator of the first vehicle and an operator of a parking facility.

17. The method as recited in claim 1, wherein presenting the information to the operator includes overlaying a color over the area and marking the location where at least one parking area is available.

18. The method as recited in claim 17, wherein marking a location where at least one parking area is available includes displaying an icon indicating the location where the parking area is available.

19. The method as recited in claim 1, wherein the parking area availability information is overidden by a special parking area.

20. The method as recited in claim 20, wherein the special parking area includes at least one of a handicapped parking area, a reserved parking area and leased parking area.

21. A method for collecting parking area availability information for an area from an onboard mobile computer and a global positioning system, comprising the steps of:
in response to receiving location information from the global positioning system and parking area availability information from the onboard mobile computer, correlating the parking area availability information as reported by the onboard computer with geographic position data as reported by the global positioning system to form correlated parking area availability information;
configuring the correlated parking area availability information to a specified format; and
transmitting the configured correlated parking area information.

22. The method as recited in claim 21, further comprising: storing the correlated parking area availability information in a set of one or more data records for further analysis.

23. A method for receiving parking area availability information for a first vehicle, the method comprising the steps of:
transmitting location information from a first computer to a second computer;
receiving the parking area availability information for an area identified by the location information; and
outputting the received parking area availability information in a user defined manner.

24. A method for conveying parking area availability information for a first vehicle, the method comprising the steps of:
maintaining a database, at a first computer, containing parking area availability information for areas identified by location information;
receiving specific location information over a network from a second computer;
accessing the database to determine the parking area availability information associated with the received specific location information; and
transmitting the determined parking area availability information to the second computer.

25. A method conveying parking area availability information for a first vehicle, the method comprising the steps of:
receiving location information over a wireless communications link from a first mobile computer;
transmitting the location information over a second communications link to a second computer;
receiving parking area availability information from the second computer based upon the location information;
formatting the received parking area availability information according to a configuration received from the mobile computer; and
transmitting the formatted parking area availability information to the mobile computer over the wireless communications link.

26. A data processing system, comprising:
a bus system;
a database connected to the bus system;
a communications unit connected to the bus system;
a memory connected to the bus system, the memory including a set of instructions; and
a processing unit connected to the bus system, wherein the processing unit executes the set of instructions from the memory to obtain geographic position data of a first vehicle via the communications system, the processing unit uses the geographic position data to retrieve information about parking area availability from the database for an area associated with the geographic position data, and the processing unit presents the information to an operator.

27. A system for conveying parking area availability information for a first vehicle, comprising:
obtaining means for obtaining geographic position data of the first vehicle;
using means for using the geographic position data to retrieve information about parking area availability for an area associated with the geographic position data; and
presenting means for presenting the information to an operator.

28. The system as recited in claim 27, wherein obtaining geographic position data of the first vehicle includes obtaining geographic position data from a Global Positioning System (GPS).

29. The system as recited in claim 27, further comprising:
receiving means for receiving from a second vehicle information about unavailability of a parking area in an area associated with the geographic location data; and
presenting means for presenting the parking area unavailability information to the operator.

30. The system as recited in claim 27, further comprising:
transmitting means for transmitting an alert if the parking area availability of the area associated with the geographical position data exceed a predetermined threshold amount; and
presenting means for presenting the alert to the operator.

31. The system as recited in claim 27, further comprising:
calculating means for calculating a score for a metropolitan area based on the parking area availability information; and
presenting means for presenting the score to the operator.

32. A system for collecting parking area availability information for an area from an onboard mobile computer and a global positioning system, comprising:
correlating means, in response to receiving location information from the global positioning system and parking area availability information from the onboard mobile computer, for correlating the parking area availability information as reported by the onboard computer with geographic position data as reported by the global positioning system to form correlated parking area availability information;
configuring means for configuring the correlated parking area availability information to a specified format; and
transmitting means for transmitting the configured correlated parking area information.

33. A system for receiving parking area availability information for a first vehicle, the method comprising:
transmitting means for transmitting location information from a first computer to a second computer;
receiving means for receiving the parking area availability information for an area identified by the location information; and
outputting means for outputting the received parking area availability information in a user defined manner.

34. A system for conveying parking area availability information for a first vehicle, comprising:
maintaining means for maintaining a database, at a first computer, containing parking area availability information for areas identified by location information;
receiving means for receiving specific location information over a network from a second computer;
accessing means for accessing the database to determine the parking area availability information associated with the received specific location information; and
transmitting means for transmitting the determined parking area availability information to the second computer.

35. A system for conveying parking area availability information for a first vehicle, comprising:
receiving means for receiving location information over a wireless communications link from a first mobile computer;
transmitting means for transmitting the location information over a second communications link to a second computer;
receiving means for receiving parking area availability information from the second computer based upon the location information;
formatting means for formatting the received parking area availability information according to a configuration received from the mobile computer; and
transmitting means for transmitting the formatted parking area availability information to the mobile computer over the wireless communications link.

36. A computer program product in a computer readable medium for conveying parking area availability information for a first vehicle, comprising the steps of:
instructions for obtaining geographic position data of the first vehicle;
instructions for using the geographic position data to retrieve information about parking area availability for an area associated with the geographic position data; and
instructions for presenting the information to an operator.

37. The computer program product as recited in claim 36, wherein obtaining geographic position data of the first vehicle includes obtaining geographic position data from a Global Positioning System (GPS).

38. The computer program product as recited in claim 36, wherein obtaining geographic position data of the first vehicle includes one of a mobile computer system and a user defined position.

39. The computer program product as recited in claim 38, wherein the user defined position includes at least one of a route name, a route number, a route mile marker, a cross street, a city, a county, a state and a zip code.

40. The computer program product as recited in claim 38, wherein the mobile computer system is at least one of a notebook computer, a personal digital assistant (PDA), an on board navigation system, an onboard computer and a cellular telephone.

41. The computer program product as recited in claim 36, wherein the geographic position data is sent by an onboard navigation system.

42. The computer program product as recited in claim 36, further comprising:
instructions for receiving from a second vehicle information about unavailability of a parking area in an area associated with the geographic location data; and
instructions for presenting the parking area unavailability information to the operator.

43. The computer program product as recited in claim 36, further comprising:
instructions for transmitting an alert if the parking area availability of the area associated with the geographical position data exceed a predetermined threshold amount; and
instructions for presenting the alert to the operator.

44. The computer program product as recited in claim 43, wherein the alert is at least one of textual, audible and tactile.

45. The computer program product as recited in claim 36, wherein parking area availability information is for a metropolitan area, the metropolitan area being partitioned into sections, and wherein the parking area availability information is obtained for the metropolitan area associated with the section.

46. The computer program product as recited in claim 36, wherein the parking area availability information is obtained from one or more parking area availability data suppliers.

47. The computer program product as recited in claim 46, wherein the parking area availability data suppliers are at least one of a municipality and a private parking area facility.

48. The computer program product as recited in claim 36, wherein conveying parking area availability information to an operator of a first vehicle traveling in a metropolitan area includes using at least one of an expert system, a neural network, a rule based system, an inference engines, and a data mining technique.

49. The computer program product as recited in claim 36, further comprising:
instructions for calculating a score for a metropolitan area based on the parking area availability information; and
instructions for presenting the score to the operator.

50. The computer program product as recited in claim 49, wherein calculating a score for the metropolitan area based on the parking area availability information includes summing scores for each section of the metropolitan area.

51. The computer program product as recited in claim 36, wherein the operator is at least one of an operator of the first vehicle and an operator of a parking facility.

52. The computer program product as recited in claim 36, wherein presenting the information to the operator includes overlaying a color over the area and marking the location where at least one parking area is available.

53. The computer program product as recited in claim 52, wherein marking a location where at least one parking area is available includes displaying an icon indicating the location where the parking area is available.

54. The computer program product as recited in claim 36, wherein the parking area availability information is overidden by a special parking area.

55. The computer program product as recited in claim 54, wherein the special parking area includes at least one of a handicapped parking area, a reserved parking area and leased parking area.

56. A computer program product in a computer readable medium for collecting parking area availability information for an area from an onboard mobile computer and a global positioning system, comprising the steps of:
instructions, in response to receiving location information from the global positioning system and parking area availability information from the onboard mobile computer, for correlating the parking area availability information as reported by the onboard computer with geographic position data as reported by the global positioning system to form correlated parking area availability information;
instructions for configuring the correlated parking area availability information to a specified format; and
instructions for transmitting the configured correlated parking area information.

57. The computer program product as recited in claim 53, further comprising storing the correlated parking area availability information in a set of one or more data records for further analysis.

58. A computer program product in a computer readable medium for receiving parking area availability information for a first vehicle, comprising:
instructions for transmitting location information from a first computer to a second computer;
instructions for receiving the parking area availability information for an area identified by the location information; and
instructions for outputting the received parking area availability information in a user defined manner.

59. A computer program product in a computer readable medium for conveying parking area availability information for a first vehicle, comprising:
instructions for maintaining a database, at a first computer, containing parking area availability information for areas identified by location information;
instructions for receiving specific location information over a network from a second computer;
instructions for accessing the database to determine the parking area availability information associated with the received specific location information; and
instructions for transmitting the determined parking area availability information to the second computer.

60. A computer program product in a computer readable medium conveying parking area availability information for a first vehicle, comprising:
instructions for receiving location information over a wireless communications link from a first mobile computer;
instructions for transmitting the location information over a second communications link to a second computer;
instructions for receiving parking area availability information from the second computer based upon the location information;
instructions for formatting the received parking area availability information according to a configuration received from the mobile computer; and
instructions for transmitting the formatted parking area availability information to the mobile computer over the wireless communications link.
